(19) United States
(12) Patent Application Publication
(10) Pub. No.: US 2025/0305436 A1
(43) Pub. Date: Oct. 2, 2025

(54) EXHAUST DEVICE

(71) Applicant: HONDA MOTOR CO., LTD., Tokyo (JP)

(72) Inventor: Shohei YASUDA, Tokyo (JP)

(21) Appl. No.: 19/087,610

(22) Filed: Mar. 24, 2025

(30) Foreign Application Priority Data
Mar. 29, 2024 (JP) 2024-057769

(51) Int. Cl. F01N 13/18; B01D 53/94; F01N 13/00

(52) U.S. Cl. CPC F01N 13/1805; B01D 53/94; F01N 13/008; B01D 2258/01; B01D 2259/4566

(57) ABSTRACT

An exhaust device (30) includes: a pair of left and right exhaust pipes (T) attached to a power unit (P) of a vehicle (1) and extending rearward; and a communication path (35) extending in the vehicle width direction and connecting the exhaust pipes (T) to each other. The communication path (35) is disposed on the downstream side in a flow path direction of exhaust gas (G) from the power unit (P), relative to a catalyst (C) stored in each of the left and right exhaust pipes (T), and an exhaust gas sensor (42) for detecting components of the exhaust gas (G) of the power unit (P) is mounted to each exhaust pipe (T) at a position between the catalyst (C) and the communication path (35).

This application is based on and claims the benefit of priority from Japanese Patent Application No. 2024-057769, filed on 29 Mar. 2024, the content of which is incorporated herein by reference.

### BACKGROUND OF THE INVENTION

### Field of the Invention

The present invention relates to an exhaust device, and, particularly, to an exhaust device having a catalyst disposed inside each of a pair of left and right exhaust pipes.

### Related Art

Conventionally, an exhaust device having a catalyst disposed inside each of a pair of left and right exhaust pipes has been known.

Japanese Unexamined Patent Application, Publication No. 2016-156330 discloses an exhaust device in which a catalyst is disposed inside each of a pair of left and right exhaust pipes, a communication path for coupling the left and right exhaust pipes is provided, and an exhaust gas sensor for detecting components of exhaust gas is attached near a connection part connecting each exhaust pipe and the communication path.
Patent Document 1: Japanese Unexamined Patent Application, Publication No. 2016-156330

### SUMMARY OF THE INVENTION

However, in the exhaust device of Japanese Unexamined Patent Application, Publication No. 2016-156330, since the exhaust gas sensor is attached near the connection part between the exhaust pipe and the communication path, there is a possibility that exhaust gas flowing backward from the communication path comes into contact with the exhaust gas sensor and affects the accuracy of detecting the components of the exhaust gas.

It is an object of the present invention to provide an exhaust device capable of solving the problem of the related art, and maintaining the accuracy of detecting the components of the exhaust gas while having the exhaust gas sensor mounted near a communication path coupling left and right exhaust pipes.

In order to achieve the above object, the present invention has a first characteristic in that, in an exhaust device (30) including: a pair of left and right exhaust pipes (T) attached to a power unit (P) of a vehicle (1) and extending rearward; and a communication path (35) extending in the vehicle width direction and connecting the left and right exhaust pipes (T) to each other, the communication path (35) is disposed on the downstream side in a flow path direction of exhaust gas (G) from the power unit (P), relative to a catalyst (C) stored in each of the left and right exhaust pipes (T), and an exhaust gas sensor (42) for detecting components of the exhaust gas (G) is mounted to the exhaust pipe (T) at a position between the catalyst (C) and the communication path (35).

Moreover, the present invention has a second characteristic in that the exhaust gas sensor (42) is attached to an inward position of the exhaust pipe (T) in the vehicle width direction, and is disposed so as not to overlap entirely with the communication path (35) in a rear view of the vehicle.

Further, the present invention has a third characteristic in that a connection part (41) between the exhaust pipe (T) and the communication path (35) is disposed on an outer side in the vehicle width direction relative to an attachment part (36) for the exhaust gas sensor (42).

Furthermore, the present invention has a fourth characteristic in that an engagement part (38) with which a muffler (M) for silencing the exhaust gas (G) engages is disposed rearward of the communication path (35), and a distance (B) from the connection part (41) to the engagement part (38) is longer than a distance (A) from the connection part (41) to the attachment part (36).

According to the first characteristic, in the exhaust device (30) including: a pair of left and right exhaust pipes (T) attached to the power unit (P) of the vehicle (1) and extending rearward; and the communication path (35) extending in the vehicle width direction and connecting the left and right exhaust pipes (T) to each other, since the communication path (35) is disposed on the downstream side in the flow path direction of exhaust gas (G) from the power unit (P), relative to the catalyst (C) stored in each of the left and right exhaust pipes (T), and the exhaust gas sensor (42) for detecting components of the exhaust gas (G) is mounted to the exhaust pipe (T) at a position between the catalyst (C) and the communication path (35), it is possible to detect the components of the exhaust gas after passing through the catalyst by the exhaust gas sensor, and it is also possible to reduce contact of the exhaust gas flowing backward from the communication path with the exhaust gas sensor. Consequently, it is possible to maintain the detection accuracy of the exhaust gas sensor.

According to the second characteristic, since the exhaust gas sensor (42) is attached to an inward position of the exhaust pipe (T) in the vehicle width direction and is disposed so as not to overlap entirely with the communication path (35) in the rear view of the vehicle, the exhaust gas sensor is less visible from the outside, the outside appearance of the vehicle is improved, and it is possible to prevent the exhaust gas sensor and the communication path from interfering with each other when attaching and detaching the exhaust gas sensor and the communication path, and improve maintainability.

According to the third characteristic, since the connection part (41) between the exhaust pipe (T) and the communication path (35) is disposed on the outer side in the vehicle width direction relative to the attachment part (36) for the exhaust gas sensor (42), it is possible to reduce contact of the exhaust gas flowing backward from the communication path with the exhaust gas sensor.

According to the fourth characteristic, since the engagement part (38) with which the muffler (M) for silencing the exhaust gas (G) engages is disposed rearward of the communication path (35), and the distance (B) from the connection part (41) to the engagement part (38) is longer than the distance (A) from the connection part (41) to the attachment part (36), it is possible to increase the distance between the exhaust gas sensor and the muffler, and, even when a drain hole is provided at a forward position of the muffler, it is possible to prevent outside air entering through the drain hole from affecting the detection accuracy of the exhaust gas sensor.

### BRIEF DESCRIPTION OF THE DRAWINGS

FIG. 1 is a left side view of a motorcycle to which an exhaust device according to an embodiment of the present invention is applied;

FIG. 2 is a partially enlarged view of FIG. 1;

FIG. 3 is a plan view of the exhaust device;

FIG. 4 is a partially enlarged view of FIG. 3;

FIG. 5 is a cross-sectional view taken along the V-V line of FIG. 4; and

FIG. 6 is a cross-sectional view taken along the VI-VI line of FIG. 4.

### DETAILED DESCRIPTION OF THE INVENTION

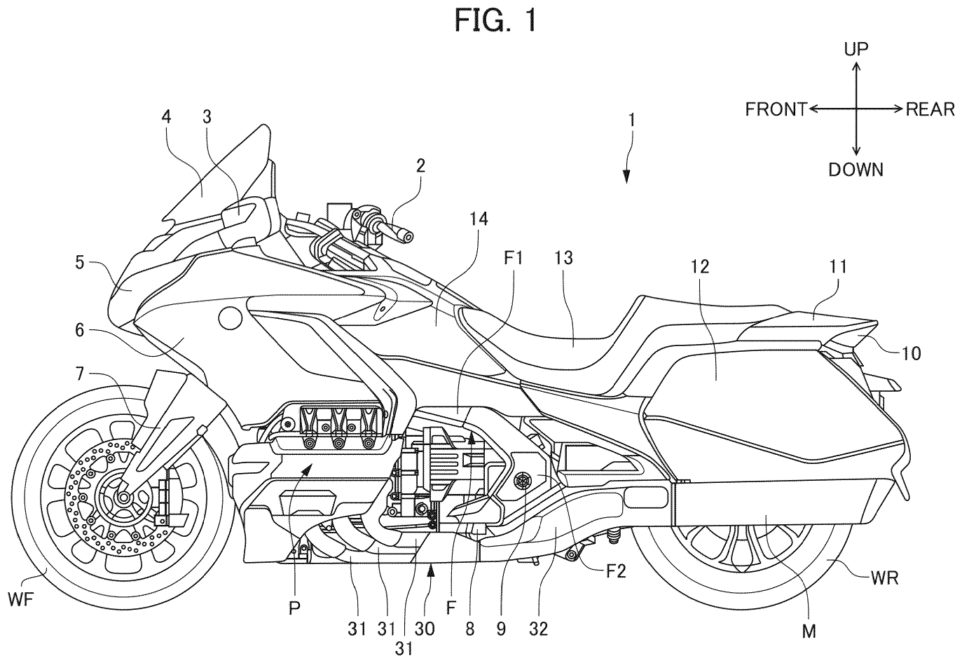

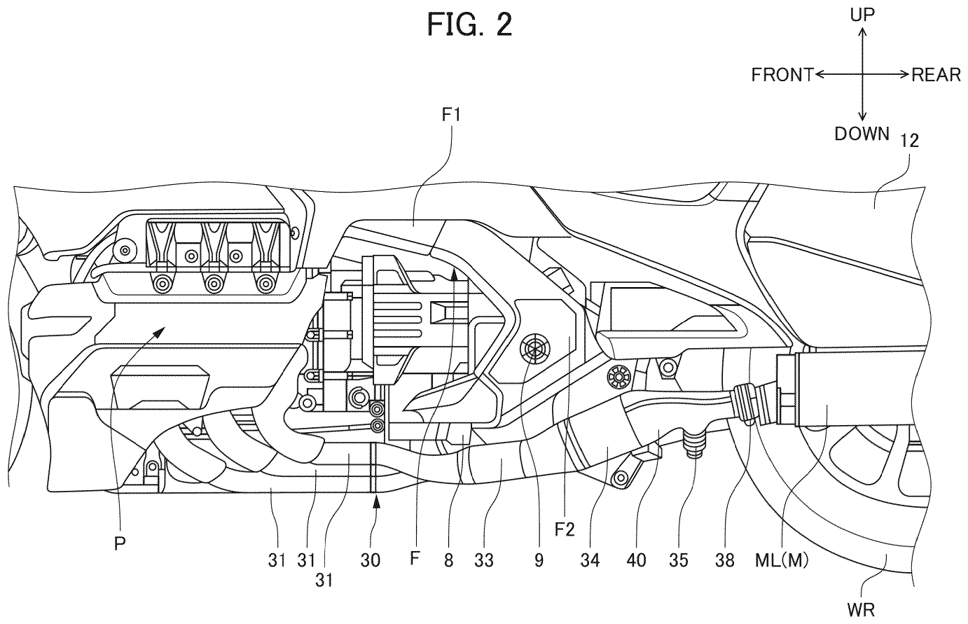

Hereinafter, a preferred embodiment of the present invention will be described in detail with reference to the drawings. FIG. 1 is a left side view of a motorcycle 1 to which an exhaust device 30 according to an embodiment of the present invention is applied. FIG. 2 is a partially enlarged view of FIG. 1. In FIG. 2, a state in which a cover member 32 for covering a portion of the exhaust device 30 has been removed is shown. The motorcycle 1 is a saddle-ride type vehicle that travels by transmitting a driving force of a power unit P, which is configured by integrating an internal combustion engine with a transmission, to a rear wheel WR through a shaft drive mechanism (not shown).

At a front end portion of each of a pair of left and right main frames F1 constituting a vehicle body frame F, an arm member 7 that rotatably supports a front wheel WF and constitutes a front suspension is supported to be movable up and down. A windscreen 4, a pair of left and right rearview mirrors 3, and a front cowl 6 for supporting a headlight 5 are disposed forward of a steering handle 2 for steering the arm member 7.

A pivot frame F2 for supporting a pivot 9 that pivotally supports a swing arm (not shown) to be swingable is coupled to a rear portion of the main frame F1 extending downward and rearward. The rear wheel WR is rotatably supported at a rear end portion of the swing arm. A fuel tank 14 extending to under a seat 13 is disposed above the main frame F1, and a rear cowl 11 for supporting a taillight device 10 is disposed behind the seat 13. A pair of left and right pannier cases 12 is mounted under the rear cowl 11.

The power unit P including a horizontally-opposed six-cylinder internal combustion engine is suspended from the main frame F1. The exhaust device 30 having a pair of left and right mufflers M (ML, MR) is attached to the power unit P. The exhaust device 30 includes: six cylinder connection pipes 31; collector pipes 33 that are each coupled to a rear portion of the cylinder connection pipes 31; catalyst storage parts 34 that are each coupled to a rear portion of each collector pipe 33; curved pipes 40 that are each coupled to a rear portion of each catalyst storage part 34; the mufflers M that are each coupled to a rear portion of each curved pipe 40; and a communication path 35 that is oriented in the vehicle width direction and couples the left and right curved pipes 40. A rear end portion of each curved pipe 40 and a front end portion of each muffler M are connected with an engagement band 38 serving as an engagement part.

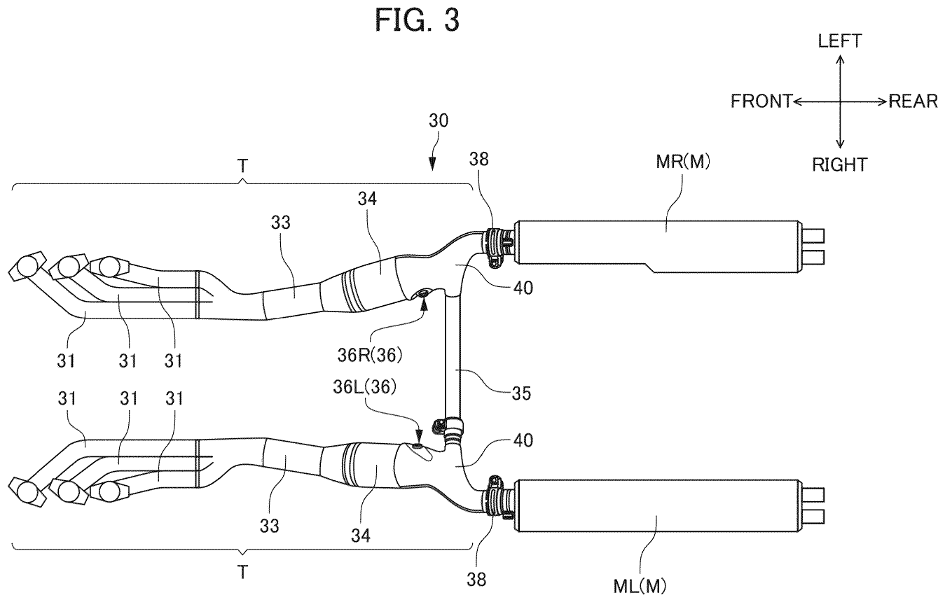

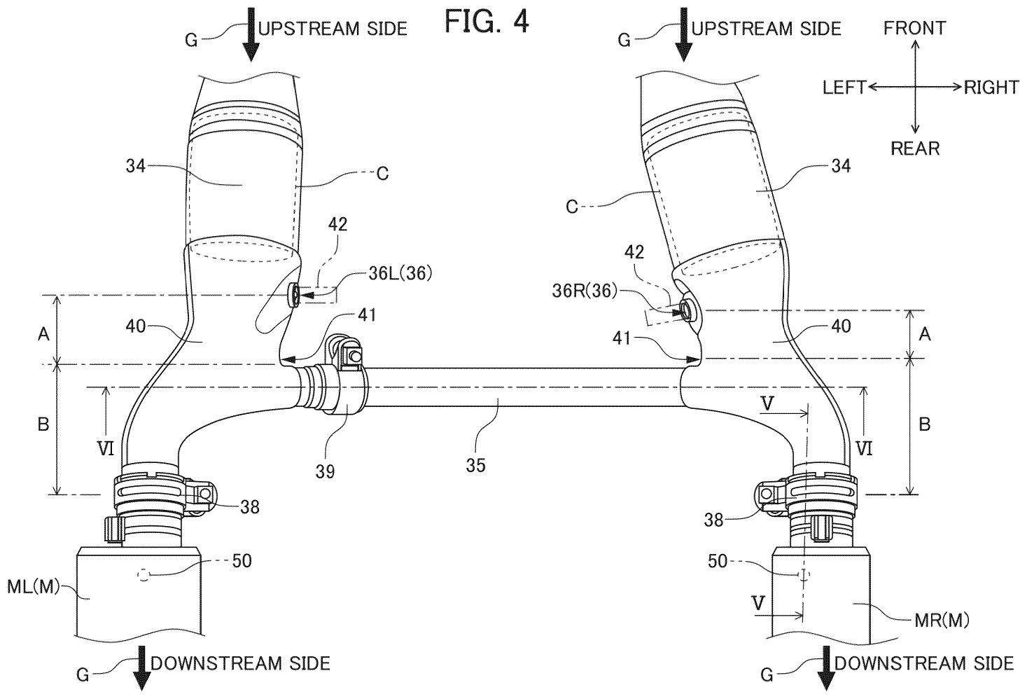

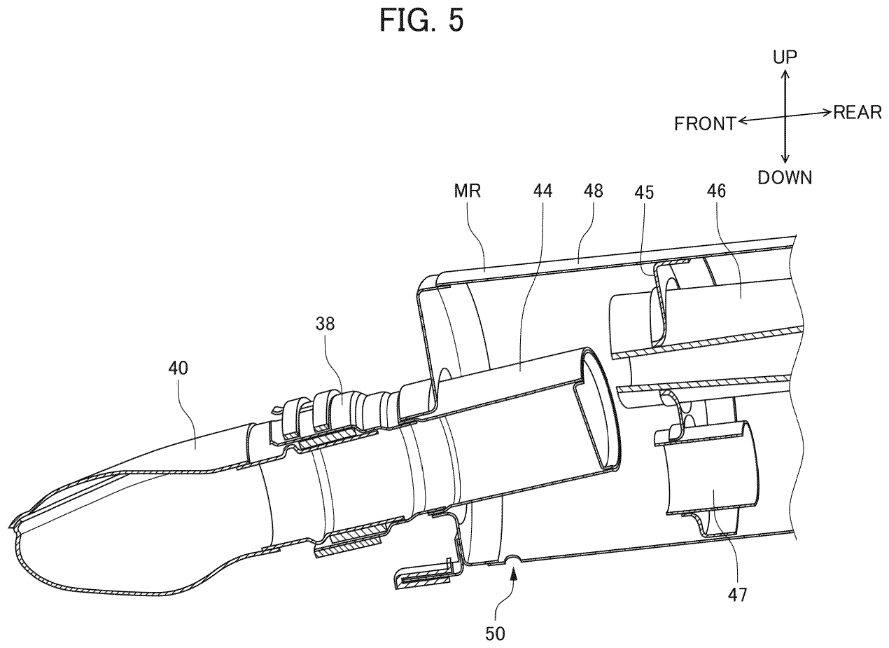

FIG. 3 is a plan view of the exhaust device 30. FIG. 4 is a partially enlarged view of FIG. 3, and FIG. 5 is a cross-sectional view taken along the V-V line of FIG. 4. The same reference numerals as those described above indicate the same or equivalent parts. As described above, each exhaust pipe T of the exhaust device 30 is constituted by the cylinder connection pipes 31, the collector pipe 33, the catalyst storage part 34, the curved pipe 40, and the communication path 35. An attachment part 36 (36L, 36R) for an exhaust gas sensor 42 that detects components of exhaust gas G is provided on the inner side of each curved pipe 40 in the vehicle width direction. Each muffler M (MR) is configured by storing an inlet member 44, a first inner pipe 46 and a second inner pipe 47 supported by a partition wall 45, etc. inside an outer shell member 48. A drain hole 50 is formed in a forward lower portion of the outer shell member 48.

The exhaust device 30 according to the present embodiment is characterized in that the communication path 35 is disposed rearward of a catalyst C stored in each of the left and right exhaust pipes T, and the exhaust gas sensor 42 is mounted to the exhaust pipe T at a position between the catalyst C and the communication path 35. Consequently, the components of the exhaust gas G after passing through the catalyst C can be detected by the exhaust gas sensor 42, and it is possible to maintain the detection accuracy of the exhaust gas sensor 42 by reducing contact of the exhaust gas G flowing backward from the communication path 35 with the exhaust gas sensor 42.

Each curved pipe 40 and the communication path 35 are connected at a connection part 41. A fastening band 39 is attached to a leftward position of the communication path 35. The present embodiment is characterized in that the connection part 41 between the curved pipe 40 and the communication path 35 is disposed on the outer side in the vehicle width direction relative to the attachment part 36 (36L, 36R) for the exhaust gas sensor 42. Consequently, contact of the exhaust gas G flowing backward from the communication path 35 with the exhaust gas sensor 42 can be reduced.

Moreover, the present embodiment is characterized in that a distance B from the connection part 41 to the engagement part 38 is longer than a distance A from the connection part 41 to the attachment part 36 (36L, 36R). Consequently, it is possible to increase the distance between the exhaust gas sensor 42 and the muffler M, and prevent outside air entering through the drain hole 50 from affecting the detection accuracy of the exhaust gas sensor 42.

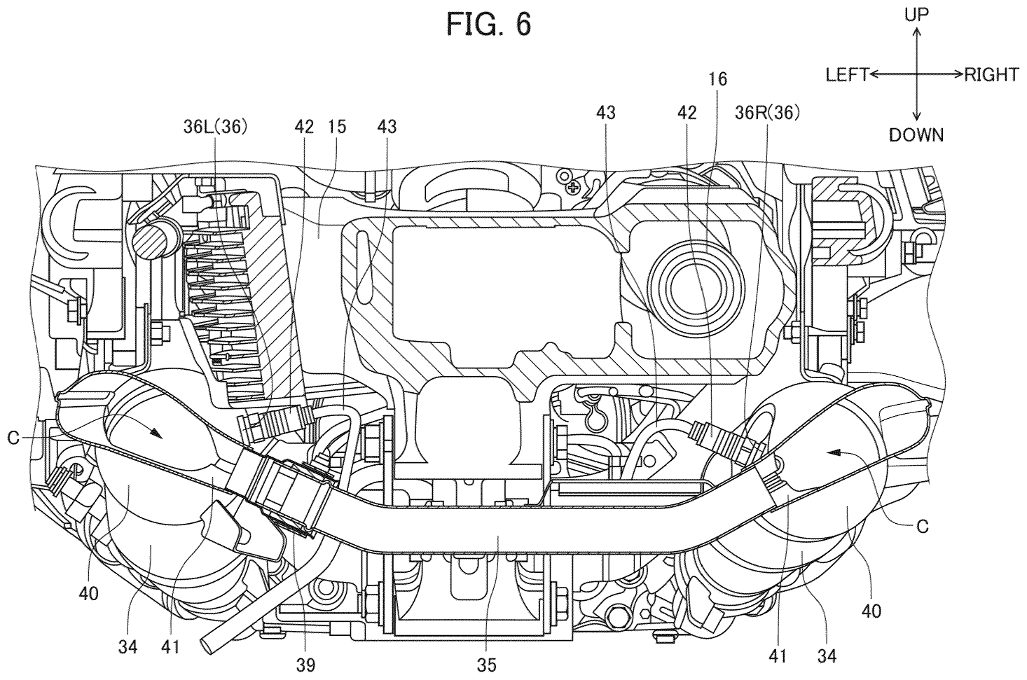

FIG. 6 is a cross-sectional view taken along the VI-VI line of FIG. 4. The same reference numerals as those described above indicate the same or equivalent parts. In this figure, the exhaust device 30 in a state of being attached to the motorcycle 1 is shown. A shaft drive mechanism 16 is disposed inside a swing arm 15 that rotatably supports the rear wheel WR. In order to dispose a straight portion of the communication path 35 downward while avoiding the swing arm 15 that swings up and down, the connection part 41 provided in the curved pipe 40 is formed into a shape inclined downward.

The exhaust gas sensor 42 is attached to an inward position of the curved pipe 40 in the vehicle width direction, and is disposed so as not to overlap entirely with the communication path 35 in a rear view of the vehicle. Consequently, the exhaust gas sensor 42 is less visible from the outside, the outside appearance of the motorcycle 1 is improved, and it is possible to prevent the exhaust gas sensor 42 and the communication path 35 from interfering with each other when attaching and detaching the exhaust gas sensor 42 and the communication path 35, and improve maintainability.

As described above, according to the exhaust device 30 of the present invention, in the exhaust device 30 including: a pair of left and right exhaust pipes T attached to the power unit P of the motorcycle 1 and extending rearward; and the communication path 35 extending in the vehicle width direction and connecting the exhaust pipes T to each other, since the communication path 35 is disposed on the downstream side in a flow path direction of the exhaust gas G from the power unit P, relative to the catalyst C stored in each of the left and right exhaust pipes T, and the exhaust gas sensor 42 for detecting components of the exhaust gas G is mounted to each exhaust pipe T at a position between the catalyst C and the communication path 35, it is possible to detect the components of the exhaust gas G after passing through the catalyst C by the exhaust gas sensor 42, and it is also possible to reduce contact of the exhaust gas G flowing backward from the communication path 35 with the exhaust gas sensor 42. Consequently, it is possible to maintain the detection accuracy of the exhaust gas sensor 42.

The form of the motorcycle, the form of the internal combustion engine, the number of cylinders, the shape and structure of the exhaust device, the mounting location and the number of the catalysts, the shape and structure of the outer shell and partition wall constituting the muffler, the material and shape of each pipe member, the shape and structure of the exhaust gas sensor, the mounting location of the exhaust gas sensor, the location of the drain hole, and so on are not limited to the above embodiment, and can be modified in various ways. The exhaust device according to the present invention can be applied to various vehicles such as three-wheel vehicles and four-wheel vehicles using a power unit including an internal combustion engine as a drive source, without being limited to motorcycles.

### EXPLANATION OF REFERENCE NUMERALS

1 . . . motorcycle (vehicle); 30 . . . exhaust device; 35 . . . communication path; 36 (36L, 36R) . . . attachment part; 38 . . . engagement part; 41 . . . connection part; 42 . . . exhaust gas sensor; P . . . power unit; T . . . exhaust pipe; C . . . catalyst, G . . . exhaust gas; M (ML, MR) . . . muffler; A . . . distance from connection part to attachment part; and B . . . distance from connection part to engagement part.

What is claimed is:

1. An exhaust device (30) comprising:
a pair of left and right exhaust pipes (T) attached to a power unit (P) of a vehicle (1) and extending rearward; and
a communication path (35) extending in a vehicle width direction and connecting the left and right exhaust pipes (T) to each other, wherein
the communication path (35) is disposed on a downstream side in a flow path direction of exhaust gas (G) from the power unit (P), relative to a catalyst (C) stored in each of the left and right exhaust pipes (T), and
an exhaust gas sensor (42) for detecting components of the exhaust gas (G) is mounted to the exhaust pipe (T) at a position between the catalyst (C) and the communication path (35).

2. The exhaust device according to claim 1, wherein
the exhaust gas sensor (42) is attached to an inward position of the exhaust pipe (T) in the vehicle width direction, and is disposed so as not to overlap entirely with the communication path (35) in a rear view of the vehicle.

3. The exhaust device according to claim 1, wherein
a connection part (41) between the exhaust pipe (T) and the communication path (35) is disposed on an outer side in the vehicle width direction relative to an attachment part (36) for the exhaust gas sensor (42).

4. The exhaust device according to claim 3, wherein
an engagement part (38) with which a muffler (M) for silencing the exhaust gas (G) engages is disposed rearward of the communication path (35), and
a distance (B) from the connection part (41) to the engagement part (38) is longer than a distance (A) from the connection part (41) to the attachment part (36).
